(19) United States
(12) Patent Application Publication
(10) Pub. No.: US 2017/0225122 A1
(43) Pub. Date: Aug. 10, 2017

(54) ETHANOL EMISSION TREATMENT SYSTEMS

(71) Applicant: Alliance Environmental Group / An F.W. Webb Company, Warwick, RI (US)

(72) Inventor: Richard C. Hittinger, Warwick, RI (US)

(21) Appl. No.: 15/424,820

(22) Filed: Feb. 4, 2017

Related U.S. Application Data
(60) Provisional application No. 62/292,011, filed on Feb. 5, 2016.

(51) Int. Cl. B01D 53/85; B01D 53/72

(52) U.S. Cl. CPC B01D 53/85; B01D 53/72; B01D 2251/95

(57) ABSTRACT

An effective ethanol emission treatment system usable at buildings such as spirit aging warehouses which biologically removes ethanol prior to air escaping to the atmosphere is disclosed. The system can be used either with or without imparting negative pressure on the building to draw the ethanol vapors into the treatment system. The system provides efficient removal of ethanol from large volumes of air having relatively low ethanol concentrations.

### CROSS-REFERENCE TO RELATED APPLICATION

This application claims the benefit of U.S. Provisional Patent Application Ser. No. 62/292,011 filed Feb. 5, 2016, which is incorporated herein by reference.

### FIELD OF THE INVENTION

The present invention relates to treatment of ethanol emissions, and more particularly relates to apparatus and methods for treating and reducing ethanol emissions from distilled spirits aging and storage facilities.

### BACKGROUND INFORMATION

The process of creating desirable tastes of many distilled spirits includes aging in wooden barrels. Such aging processes generate significant amounts of ethanol due to evaporation through the wooden barrels. This loss of ethanol is known in the industry as the “angels' share”. These ethanol emissions can be very significant depending on the size of the warehouse, and they cannot easily be controlled since the aging warehouses are typically not climate controlled and are generally open to the outside atmosphere. Ethanol is a volatile organic compound (VOC), and emissions thereof can lead to photochemical production of ground-level ozone, one of the Criteria Pollutants monitored and controlled by the United States Environmental Protection Agency.

In many cases, angels' share ethanol loss is the suspected cause of impacts to surrounding properties associated with the growth of a black fungus such as Baudoinia compniacensis, which is sometimes referred to as “whiskey fungus”. Baudoinia species use ethanol, among other sources, for carbon nutrition and can withstand high temperatures. Ethanol in the vapor phase is also shown to accelerate the growth of the fungus and stimulate the germination of spores.

Cosmetic and other aesthetic impacts caused by Baudoinia have caused regulators to consider ethanol emission controls for spirit aging warehouses, even though these emissions have heretofore been considered fugitive emissions. A regenerative thermal oxidizer (RTO) has been developed in an attempt to control ethanol emissions. Although RTO technology may provide an effective method of controlling high concentration VOC emissions, the technology requires heating of air flowing through a control device and works best when high concentrations of VOCs are present. Large amounts of supplemental heat are required if the concentrations of VOCs are not high enough, especially when large volumes of air need to be treated. Because of the method of aging in the barrels and the design of the existing warehouses, it is impractical to design a method of collecting high concentration VOC vapors to feed an RTO. Therefore, any application of RTO technology to existing warehouses would likely be very expensive in terms of both capital and operating costs.

### SUMMARY OF THE INVENTION

The present invention provides an effective treatment system usable at buildings such as spirit aging warehouses to duct vapors through an apparatus for biological removal of ethanol prior to air escaping to the atmosphere. The system can be used either with or without imparting negative pressure on the building to draw the ethanol vapors. The system provides efficient removal of ethanol from large volumes of air having relatively low ethanol concentrations. Ethanol vapors may be removed with a low energy demand.

An aspect of the present invention is to provide an ethanol emission treatment system for reducing levels of ethanol generated from a building, the system comprising an enclosure comprising at least one inlet opening structured and arranged to provide flow communication with an interior of a building and at least one outlet opening, and multiple air-permeable microbial support media trays in the enclosure, wherein the multiple support media trays are structured and arranged in the enclosure to hold the microbial support media while allowing airflow through the support media trays from the inlet opening to the outlet opening of the enclosure.

Another aspect of the present invention is to provide a method of reducing ethanol emissions from a building, the method comprising drawing ethanol-containing air from a building into a treatment system comprising an enclosure and at least one support media tray containing microbial support media; passing the ethanol-containing air through the at least one support media tray to contact at least a portion of the ethanol with microorganisms in the microbial support media to thereby allow the microorganisms to oxidize the ethanol; and exhausting air from the enclosure containing a lower level of ethanol than an ethanol level of the ethanol-containing air drawn into the enclosure.

A further aspect of the present invention is to provide microbial support media inoculated with ethanol-oxidizing microorganisms for use in ethanol emission treatment systems and methods as described above.

These and other aspects of the present invention will be more apparent from the following description.

### BRIEF DESCRIPTION OF THE DRAWINGS

FIG. 1 is a partially schematic side view of an ethanol effluent treatment system installed adjacent to a building in accordance with an embodiment of the present invention.

FIG. 2 is a partially schematic isometric view of an ethanol effluent treatment system in accordance with an embodiment of the present invention.

FIG. 3 is a partially schematic top view of an ethanol effluent treatment system installed adjacent to a building in accordance with an embodiment of the present invention.

FIG. 4 is an isometric view and

FIG. 5 is a top view of a support media tray for use in a treatment system in accordance with an embodiment of the present invention.

FIG. 6 is a partially schematic front view of an ethanol effluent treatment system and ductwork in accordance with an embodiment of the present invention.

FIG. 7 is a partially schematic isometric view of an ethanol effluent treatment system including an inlet duct in accordance with an embodiment of the present invention.

FIG. 8 is a partially schematic isometric view of an ethanol effluent treatment system including another inlet duct in accordance with an embodiment of the present invention.

FIG. 9 is a photograph of wood chips that may be used as microbial support media in a treatment system in accordance with an embodiment of the present invention.

FIG. 10 is a photograph of wood chips that have been inoculated with ethanol-oxidizing microbial populations for use in a treatment system in accordance with an embodiment of the present invention.

### DETAILED DESCRIPTION

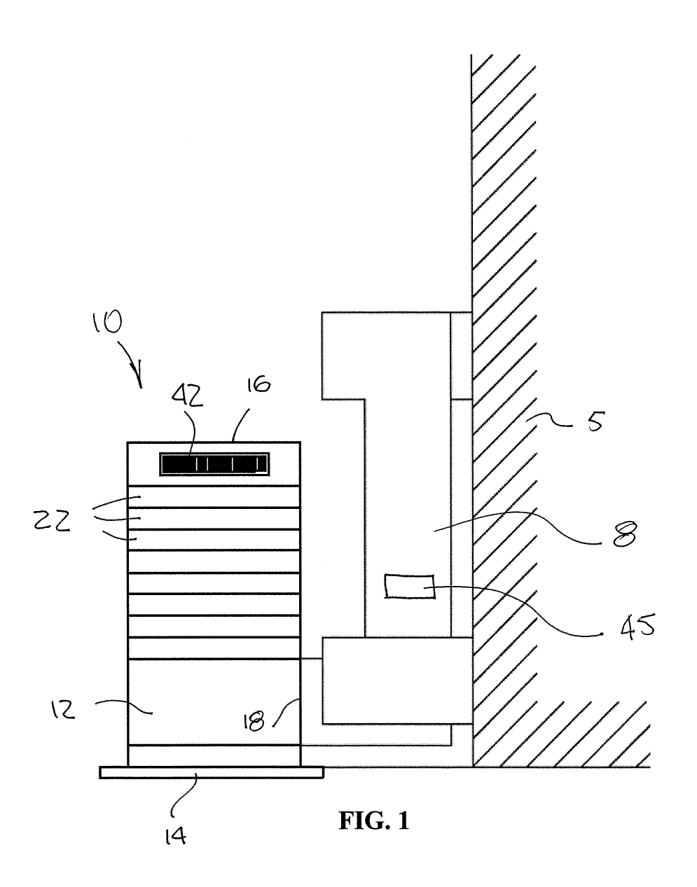

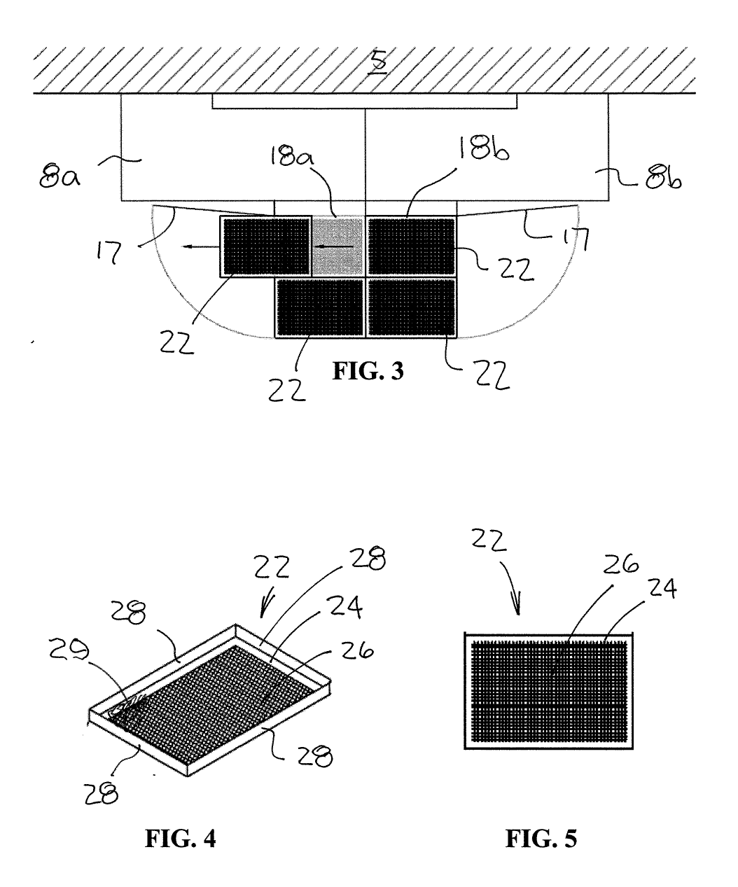

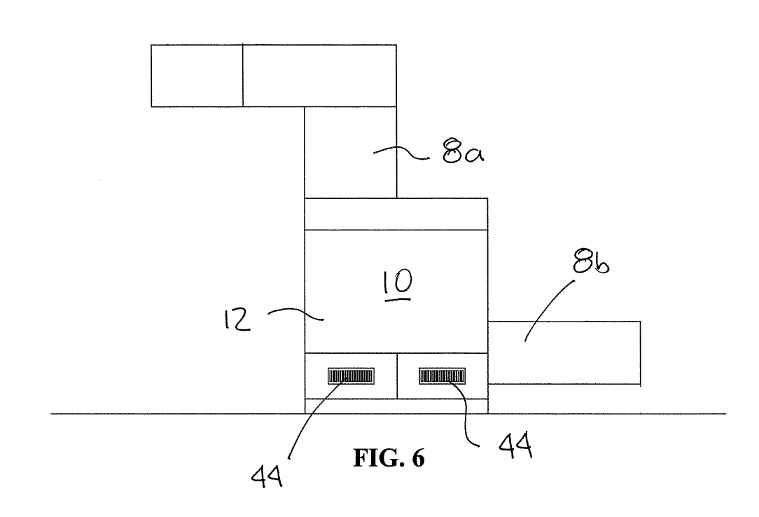

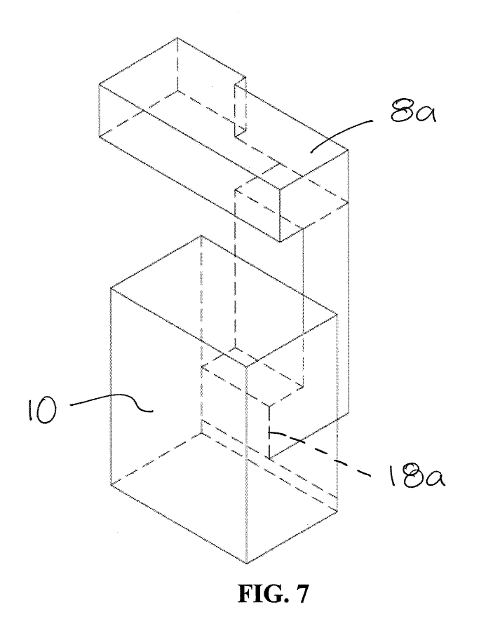

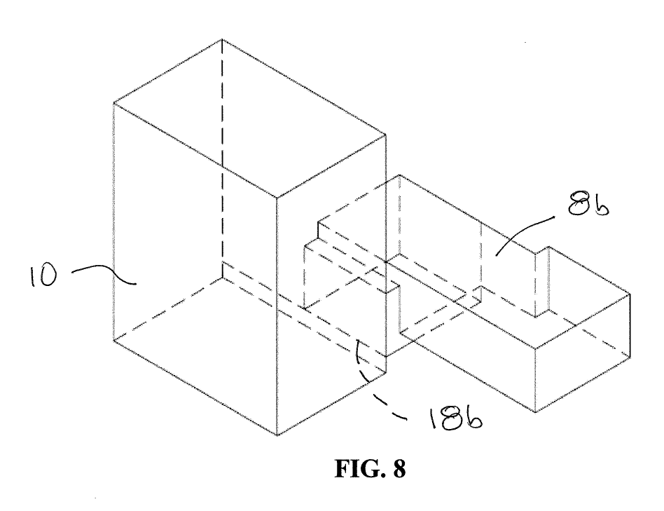

FIGS. 1-8 illustrate embodiments of ethanol effluent treatment systems 10 in accordance with embodiments of the present invention. As shown in FIG. 1, the treatment system 10 may be installed adjacent to a building 5 containing airborne ethanol, such as a distilled spirits warehouse or storage facility. The treatment system 10 is in gas flow communication with the ethanol-generating building 5 via an air duct 8 which transports airborne ethanol from the building 5 to the treatment system 10.

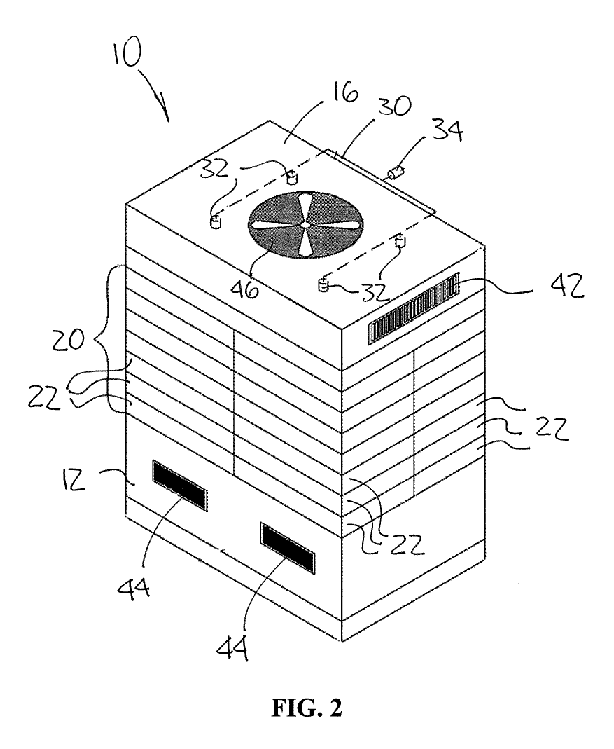

As shown most clearly in FIGS. 1 and 2, the treatment system 10 includes an enclosure 12, base 14 and top panel 16. An inlet opening 18 is provided in a lower portion of the enclosure 12 near the base 14 to allow airflow through the duct 8 into the enclosure 12. An array of stacked trays 20 is provided in the treatment system 10, including individual support media trays 22.

The treatment system 10 of the present invention may be installed in warehouse to duct vapors from existing vents through a specially designed control device using biological removal of ethanol prior to any air escaping to the atmosphere.

As shown in FIG. 2, the treatment system 10 includes a water delivery and spray system 30 comprising four water spray heads 32 connected to a water supply line 34. As more fully described below, water delivered through the supply line 34 to the spray heads 32 is used to maintain a moist atmosphere inside the enclosure 12. The spray heads 32 may be provided with a timer (not shown) to maintain a desired moisture level in support media contained on the trays 22. Timer settings for the water spray can be adjusted based on parameters such as the relative moisture in the air that is venting.

As further shown in FIGS. 1, 2 and 6, the treatment system 10 may optionally include a top vent 42 on each side of the enclosure 12 and/or bottom vents 44 on the front panel of the enclosure 12. The top and bottom vents 42 and 44 may be dampered for selective opening and closing of the vents during operation of the treatment system. For example, the bottom vents 44 may be standard one-way vents that allow ambient air to be drawn into the enclosure 12. In certain embodiments, the exhaust fan 46 may run constantly, or the exhaust fan 46 may run intermittently, e.g., to draw a desired volume of ethanol-containing air into the enclosure and hold the air inside for a selected dwell time. In certain embodiments, the top and bottom vents 42 and 44 may be permanently dampered or eliminated.

As shown in FIG. 2, the treatment system 10 includes an exhaust fan 46 on the top panel 16. The exhaust fan 46 may be used to draw ethanol-containing air through the duct 8 from inside the building 5. In certain embodiments, the duct 8 may be provided with at least one conventional one-way vent 45 that permits ambient air outside the building 5 to be drawn into the duct and into the enclosure 12 of the treatment system 10. Such one-way vent(s) prevent air from escaping the duct 8 while allowing ambient air to enter. In certain embodiments, if the exhaust fan 46 is not in use, it can be closed or dampered in order to prevent the escape of air through the top panel 16 of the enclosure 12. However, as described above, the exhaust fan 46 may constantly run to draw ethanol-containing air from inside the building 5 and/or to draw fresh air from outside the building into the enclosure 12 of the treatment system 10.

As shown in FIG. 3, each support media tray 22 may be removed from the enclosure 12 by sliding the tray 22 sideways. In the embodiment shown, opposing doors 17 are provided on opposite sides of the enclosure 12 to allow such tray removal. The doors 17 allow support media trays 22 to be changed one level at a time or levels can be moved to assure that active cultures are not lost at time of support media change.

As shown in FIGS. 3-5, each support media tray 22 includes a bottom panel 24 including an air permeable mesh material 26 capable of holding microbial support media 29 while allowing air and vapor flow through the bottom panel 24. Each tray 22 includes sidewalls 28 which help to contain the microbial support media 29 contained in the tray 22. Each tray 22 may have a height, width and depth selected to house the support media within the enclosure 12. The specific dimensions may vary according to the particular application.

During operation of the treatment system 10, the arrangement of the support media trays 22 may be varied, e.g., to move lower trays to upper positions within a vertical stack and vice versa in order to change the order in which the air flowing through the enclosure contacts the support media trays 22.

FIGS. 3 and 6-8 illustrate air duct configurations in accordance with embodiments of the present invention. In the embodiment shown, a first air duct 8a communicates with a first inlet opening 18a, while a second air duct 8b communicates with a second inlet opening 18b. In the embodiment shown, the first air duct 8a exits the building 5 at a relatively high elevation, while the second air duct 8b exits the building 5 at a relatively low elevation, e.g., in order to match an existing exhaust duct structure of the building 5. Ducting to the treatment system may be adjusted specific to each facility, specific vent locations and the location where the tray unit can best be located. In order to optimize the capture of ethanol emissions, it is desirable to attach all atmospheric vents of a building 5 to the treatment system 10.

Embodiments of the treatment system of the present invention can be used either with or without imparting negative pressure on the building 5 to draw ethanol vapors into the treatment system 10. The treatment system 10 may be designed such that it can be attached to existing atmospheric vents at any distilled beverage aging warehouse. Such treatment reduces the total ethanol emissions from these warehouses, thereby reducing contribution to ground level ozone and avoiding the potential for contributing to black mold growth. The present treatment system 10 allows significant air to flow, and can be applied with a slight negative pressure, but no negative pressure is necessary to allow treatment of vapors that exhaust through the atmospheric vents. This control of vent gas without drawing negative pressure is advantageous in order to allow the aging process to continue while effectively controlling the ethanol emissions. This balance of flow may be accomplished through the use of the dampered vents in the top end of the tray enclosure. If negative pressure is imparted on the warehouse, ventilation may be improved by installing one-way gravity vents to allow make-up air to enter the warehouse.

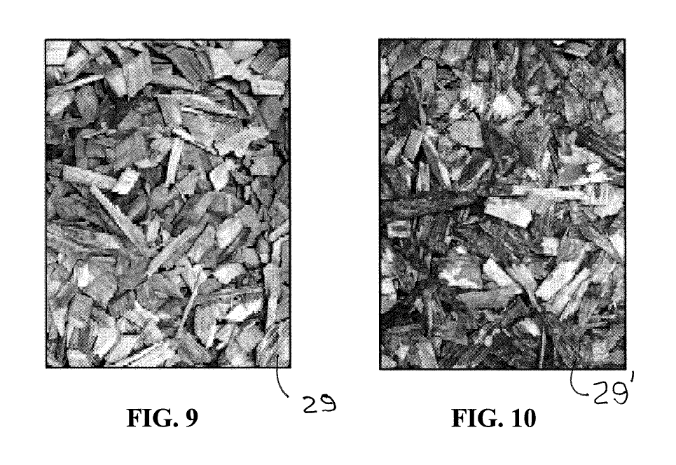

FIGS. 9 and 10 are photographs of microbial support media 29 in the form of wood chips that may be loaded into the support media trays 12 in accordance with embodiments of the present invention. The wood chips 29 shown in FIG. 9 have been inoculated with active microbial cultures, while the inoculated wood chips 29 shown in FIG. 10 have been used in a treatment system of the present invention for several days to capture and oxidize ethanol with the microbes present on the wood chips.

The enclosure 12 of the treatment system 10 may have a height, width and depth selected to house the support media trays 22 and other components of the treatment system 10. The enclosure 12 includes levels of support media trays 22 that hold support media within the enclosure 12. In the embodiment shown, there are eight levels of trays 22, but any other suitable number of levels of trays may be used. For example, there may be one, two, four, six, ten or more levels of trays. It has been found that, with eight levels of trays, removal of ethanol from air venting through the system 10 with active cultures may be in excess of 99% efficient. In the embodiment shown, there are four individual trays 22 on each of the eight levels of trays 22, but any other suitable number of trays may be used on each level to provide the required air flow rates and desired maximum system pressure drop. For example, one, two, three, five or more trays may be used on each level of trays.

Each tray 22 may be made of structurally supported stainless steel mesh 26, capable of holding up to 300 pounds of support media including moisture and active culture. However, it is to be understood that any other suitable material, such as plain steel, galvanized steel, aluminum and the like may be used to make the tray. In certain embodiments, the entire enclosure 12 may hold up to 9,600 pounds or more of support media. In an embodiment of the present invention, the support media may be wood chips between 1 to 3 inches in size. However, it is to be understood that any other suitable size of wood chips may be used. In addition, any other suitable support media may be used. For example, wheat straw, compost, peels, synthetic materials, polymeric spheres, rocks, volcanic rocks or combinations of such materials and the like may be used to provide the support media of the treatment system 10.

An active culture is provided on the support media and includes one or a variety of microorganisms. In an embodiment of the invention, in an existing facility, moist wood chips may be populated with a naturally occurring mix of fungi and bacteria that will adequately oxidize ethanol from the treatment air. In an embodiment of the invention, in new facilities or where sufficient colonization has not occurred within a reasonable time, e.g., 14 days of system operation, the support media in one or more of the trays may be inoculated with microorganisms known to be actively degrading ethanol, e.g., the support media placed in the bottom tray and/or top tray may contain inoculated support media. The microorganisms may be grown on the support media by any suitable technique, such as immersion or spraying with a liquid containing ethanol-utilizing microbes as described in the example below.

In an embodiment of the present invention, effluent gas from the building 5 flows into the enclosure 12 of the treatment system 10 and is at least partially absorbed into moisture on the media so that it can come into contact with the active culture. The VOCs contained in the effluent gas, including ethanol, are absorbed into the active culture and are degraded by the microorganisms. The VOCs may be first oxidized by the microorganisms, and then may be broken down to various reaction products. The operating conditions of the enclosure 12 of the treatment system 10 may be controlled to maintain active cultures, while providing the microorganisms with sufficient nourishment and ensuring that the adequate amount of VOCs are being removed from the effluent gas. The flow rate of air through the enclosure and out through the exhaust fan 46 may be controlled to provide sufficient dwell time in the enclosure to achieve the desired biological oxidation of ethanol. For example, exhaust flow rates of from zero to 10,000 cfm may be used, or from 0.1 to 5,000 cfm, or from 0.5 to 2,500 cfm. The exhaust flow rate may be held constant, or may be varied as desired. In certain embodiments, the flow rate may be reduced or stopped periodically to increase dwell time of the air inside the enclosure, e.g., for batch processing of selected volumes of air.

Bacteria then may be inoculated onto the support media, or which may grow on the support media during operation of the treatment system 10, in accordance with embodiments of the present invention may include the following groups (in addition to fungi, algae, protozoa, rotifers and other aerobic and anaerobic microbial populations): the spirochetes; aerobic/microaerophilic, motile, helical/vibroid, and gram-negative bacteria; nonmotile (or rarely motile), gram-negative bacteria; gram-negative aerobic/microaerophilic rods and cocci; facultatively anaerobic gram-negative rods; gram-negative, anaerobic, straight, curved, and helical bacteria; dissimilatory sulfate- or sulfur-reducing bacteria; anaerobic gram-negative cocci; anoxygenic phototrophic bacteria; oxygenic phototrophic bacteria; aerobic chemolithotrophic bacteria and associated organisms; budding and/or appendaged bacteria; sheathed bacteria; nonphotosynthetic, nonfruiting gliding bacteria; the fruiting, gliding bacteria and the myxobacteria; gram-positive cocci; endospore-forming gram-positive rods and cocci; regular, nonsporing, gram-positive rods; irregular, nonsporing, gram-positive rods; the mycobacteria; the actinomycetes; nocardioform actinomycetes; genera with multiocular sporangia; actinoplanetes; streptomycetes and related genera; maduromycetes; thermomonospora and related genera; thermoactinomycetes; genus glycomyces, genus kitasatospira and genus saccharothrix; the mycoplasmas—cell wall-less bacteria; the methanogens; archaeal sulfate reducers; extremely halophilic, archaeobacteria (halobacteria); cell wall-less archaeobacteria; and extremely thermophilic and hyperthermophilic SO-metabolizers.

In addition to the above-listed bacteria examples, facultative anaerobes and microaerophilics, which are bacteria capable of surviving at low levels of oxygen, may also be used in accordance with embodiments of the present invention. They may not require strict anaerobic conditions such as the obligate anaerobes. Examples include acidophilic, alkaliphilic, anaerobe, anoxygenic, autotrophic, chemolithotrophic, chemoorganotroph, chemotroph, halophilic, methanogenic, neutrophilic, phototroph, saprophytic, thermoacidophilic and thermophilic bacteria.

Representative fungi that may be used in accordance with embodiments of the present invention include: phylum ascomycota, class neolectomycetes, class pneumocystidomycetes, class schizosaccharomycetes, and class taphrinomycetes; subphylum pezizomycotina, class arthoniomycetes, class dothideomycetes (genus baudoinia), class geoglossomycetes, class eurotiomycetes, and class laboulbeniomycetes; class lecanoromycetes, subclass acarosporomycetidae, subclass lecanoromycetidae, and subclass ostropomycetidae; class leotiomycetes; class lichinomycetes; class orbiliomycetes; class pezizomycetes; class sordariomycetes, subclass hypocreomycetidae, subclass sordariomycetidae, and subclass xylariomycetidae; subphylum saccharomycotina, class saccharomycetes; phylum basidiomycota, subphylum agaricomycotina, class agaricomycetes, class dacrymycetes, class tremellomycetes, subphylum pucciniomycotina, class agaricostilbomycetes, class attractiellomycetes, class classiculomycetes, class cryptomycocolacomycetes, class cystobasidiomycetes, class microbotryomycetes, class mixiomycetes, class pucciniomycetes, subphylum ustilaginiomycotina, class ustilaginomycetes, and class exobasidiomycetes; phylum chytridiomycota; phylum glomeromycota, class glomeromycetes; and phylum zygomycota, class trichomycetes, and class zygomycetes.

The following example is intended to illustrate various aspects of the present invention, and are not intended to limit the scope of the invention.

### EXAMPLE

A test chamber was constructed using a prefabricated rack made of welded aluminum. The rack was designed to hold up to 20 trays weighing as much as 100 pounds each. A total of eight galvanized steel trays containing screened bottoms (16-gauge, 1-inch by 0.5-inch) were installed. The weights of these trays ranged from approximately 5.5 to 6.0 pounds each. The rack was enclosed and made air-tight on all four sides using gasketed doors and silicone-sealed seams. A dosing chamber was installed at the bottom of the assembly, and an inline fan was installed within a six-inch exhaust duct to draw the air through the testing unit. Small holes were drilled at the base on the unit, between the four lower trays and four upper trays, and at the top of the assembly prior to the exhaust duct. These holes were installed for the collection of midfluent ethanol concentration data, and for spraying the treatment media with water to maintain the desired humidity levels within the test unit.

The treatment media used for pilot testing consisted of hardwood chips coated with bacterial, fungal, and protozoan cultures. To prepare this media, a broad spectrum biological liquid sludge culture was used. The sludge was kept aerated prior to testing and was introduced to ethanol as its sole food source to stimulate microbes that are able to utilize ethanol as a source of nutrition. This culture had been maintained on an ethanol food supply for several weeks at the time of inoculation. The wood chips utilized, which were thoroughly moistened with water prior to the initiation of testing, were a mixture of oak, maple and walnut with sizes of approximately 1-inch by 1.5 inches by 0.25 inches.

Day No. 1 the test was initiated. The eight trays were filled with the moistened wood chips until the weight of each tray was measured to be 20 pounds (approximately 14 to 14.5 pounds of wood chips per tray). Approximately 25 ounces of the activated microbial culture were then added to each tray, after which the unit was sealed and the testing commenced. A 95% ethanol solution was added continuously to the dosing chamber at the bottom of the assembly using a liquid dripper similar to the type used for dripping water into animal cages. During testing, the drip rate was varied such that the ethanol solution was added at rates between approximately 0.5 and 4.2 grams per minute. The humidity of the air stream inside the exhaust duct was measured to be 77%. Variations in the humidity level throughout the pilot testing were measured.

During the initial stages of testing, the air flow rate was measured to be 305 feet per minute (fpm) at the test unit inlet. It was identified that the flow was not uniform at the outlet, with flow rates ranging from 310 fpm (4 inches into the exhaust duct) to 820 fpm (1 inch into the duct). A vertical straightener was installed within the exhaust duct to reduce the cyclonic nature of the effluent air flow, and the damper for the fan was partially closed. The subsequent air flow rates at the outlet ranged from 250 fpm (five inches into the duct) to 660 fpm (one inch into the duct). The average effluent flow rate of 442 fpm was used to determine the volumetric flow rate, which was calculated to be approximately 86.6 cubic feet per minute (cfm) based on the 6-inch-diameter of the exhaust duct. Since the internal volume of the test chamber was 17.3 cubic feet (CF), the detention time in the chamber was 12 seconds. Since there was an average of approximately 3.5-inches of wood chips in each tray, there was about 7.5 CF of media, so the contact time with the media itself was approximately 5 seconds.

Ethanol concentrations were measured using a photoionization detector (PID) on Day Nos. 1 and 3, and were measured using a flame ionization detector (FID) on Day Nos. 6 through 9. Based on available industry literature and field calibration data, the PID readings were multiplied by a factor of 5.0 to obtain the actual ethanol concentrations in units of parts per million by volume (ppmv). With regard to the FID, per information provided by the equipment vendor, the collected readings were multiplied by a factor of 5.2 to obtain the ethanol concentrations in units of ppmv. The PID/FID readings are summarized in the following table. The response of the FID was more rapid and steady than those of the PID, so the FID results are the preferred readings.

TABLE 1
Ethanol Concentrations and Removal
Efficiency Day Nos. 1, 3 and 6-9

| | | | | | Ambient/ | |
|---|---|---|---|---|---|---|
| | | | Inlet | Outlet | Room | |
| | | | Ethanol | Ethanol | Ethanol | |
| | | | Concen- | Concen- | Concen- | Removal |
| | | | tration | tration | tration | Efficiency |
| Day No. | Time | | (ppm) | (ppm) | (ppm)¹ | (percent)² |
| 1 | 2:40 | PM | 18.0 | 8.0 | 5.0 | 83.3 |
| 1 | 2:54 | PM | 28.5 | 8.0 | 4.5 | 87.7 |
| 1 | 3:00 | PM | 48.0 | 11.0 | 5.5 | 88.5 |
| 1 | 3:08 | PM | 73.0 | 12.5 | 7.0 | 92.5 |
| 1 | 3:21 | PM | 112 | 20.5 | — | 81.7 |
| 1 | 3:30 | PM | 144 | 35.0 | — | 75.7 |
| 1 | 3:49 | PM | 137 | 43.0 | — | 68.6 |
| 3 | 10:52 | AM | 28.5 | <2.5 | <2.5 | 100 |
| 3 | 11:19 | AM | 56.0 | 12.0 | — | 78.6 |
| 3 | 11:39 | AM | 46.5 | 19.5 | — | 58.1 |
| 6 | 1:56 | PM | 172 | <2.6 | <2.6 | 100 |
| 6 | 2:02 | PM | 97.8 | <2.6 | <2.6 | 100 |
| 6 | 2:07 | PM | 281 | <2.6 | <2.6 | 100 |
| 6 | 2:15 | PM | 291 | <2.6 | <2.6 | 100 |
| 6 | 2:25 | PM | 276 | <2.6 | <2.6 | 100 |
| 6 | 2:36 | PM | 333 | <2.6 | <2.6 | 100 |
| 6 | 3:55 | PM | 619 | 14.6 | — | 97.6 |
| 6 | 4:08 | PM | 572 | <2.6 | — | 100 |
| 6 | 4:20 | PM | 588 | <2.6 | <2.6 | 100 |
| 6 | 4:35 | PM | 494 | <2.6 | <2.6 | 100 |
| 6 | 4:48³ | PM | 73.0 | 13.5 | 7.0 | 91.9 |
| 6 | 4:48⁴ | PM | 468 | <2.6 | <2.6 | 100 |
| 7 | 8:24 | AM⁵ | 78.0 | 44.7 | 5.7 | 50.0 |
| 7 | 8:29 | AM⁵ | 63.4 | 36.4 | <2.6 | 42.6 |
| 7 | 8:34 | AM | 60.3 | <2.6 | <2.6 | 100 |
| 7 | 8:39 | AM | 78.0 | <2.6 | <2.6 | 100 |
| 7 | 1:21 | PM | 156 | <2.6 | <2.6 | 100 |
| 7 | 1:28 | PM | 172 | <2.6 | <2.6 | 100 |
| 8 | 12:30 | PM | 1,144 | 101 | 13.5 | 92.4 |
| 8 | 12:38 | PM | 1,352 | 130 | <2.6 | 90.4 |
| 8 | 12:46 | PM | 1,684 | 166 | 3.1 | 90.3 |
| 8 | 12:53 | PM | 1,773 | 192 | <2.6 | 89.2 |
| 8 | 1:06 | PM | 1,888 | 203 | <2.6 | 89.2 |
| 8 | 1:16 | PM | 2,163 | 231 | <2.6 | 89.3 |
| 8 | 1:22 | PM | 1,945 | 250 | <2.6 | 87.1 |
| 8 | 1:27 | PM | 1,498 | 224 | <2.6 | 85.0 |
| 8 | 1:40 | PM | 2,194 | 250 | <2.6 | 88.6 |
| 8 | 1:44 | PM | 1,659 | 244 | <2.6 | 85.3 |
| 8 | 1:53 | PM | 1,602 | 244 | <2.6 | 84.8 |
| 8 | 2:05 | PM | 1,118 | 187 | <2.6 | 83.3 |
| 8 | 2:15 | PM | 894 | 166 | <2.6 | 81.4 |
| 8 | 2:26 | PM | 894 | 139 | <2.6 | 84.5 |
| 8 | 2:35 | PM | 806 | 131 | <2.6 | 83.7 |
| 8 | 2:46 | PM | 582 | 107 | <2.6 | 81.6 |
| 8 | 3:30 | PM | 414 | 89.4 | <2.6 | 78.4 |
| 8 | 3:40 | PM | 371 | 77.5 | <2.6 | 79.1 |
| 8 | 3:50 | PM | 282 | 68.1 | <2.6 | 75.9 |
| 8 | 4:00 | PM | 268 | 62.4 | <2.6 | 76.7 |
| 8 | 4:10 | PM | 245 | 56.2 | <2.6 | 77.1 |
| 8 | 4:20 | PM | 239 | 45.8 | <2.6 | 80.8 |
| 8 | 4:30 | PM | 204 | 43.2 | <2.6 | 78.8 |
| 9 | 7:30 | AM | 1,331 | 398 | 133 | 80.1 |
| 9 | 7:40 | AM | 1,206 | 357 | 85.3 | 77.5 |
| 9 | 7:50 | AM | 562 | 249 | 68.6 | 67.9 |
| 9 | 8:00 | AM | 323 | 213 | 31.7 | 43.9 |

¹No reading was collected at this time.
²If ambient air ethanol readings were detected above the instrument detection limit of 0.5 ppmv, the detected concentrations were subtracted from the outlet concentrations prior to calculating the removal efficiency.
³This reading was collected using the PID.
⁴This reading was collected using the FID.
⁵It is believed that the instrument was not yet fully started (i.e. “warmed up”) during the collection of these two readings.

Based on the data collected, there is no definitive relationship between the inlet concentration and the treatment system removal efficiency. However, there is a slight trend for the removal efficiency to be higher with increased inlet concentrations.

The average measured removal efficiency was 85.4%. For typical spirit aging warehouses, it is expected that the ambient air ethanol concentration will be in the range of 200 milligrams per cubic meter (mg/m³), which is equivalent to approximately 106 ppmv based on the molecular weight of ethanol. Based on the data collected during the test, this concentration can be reduced to levels of approximately 15 ppmv or lower using the technology described herein. It is also noted that the primary organic component of the ethanol, which is suspected to stimulate the growth of the Baudoinia fungus, is believed to be largely or wholly removed by the activated culture during the treatment process. Testing is currently ongoing to improve the average removal efficiency rate.

The humidity level in the test unit ranged from 33% to 78%. In particular, on the final day of testing (Day No. 9), the lowest humidity level of 33% was recorded and the corresponding removal efficiencies were limited to values between 43.9% and 80.1%. As such, the moisture level appears to play a significant role in the ability of the activated culture to remove ethanol from the vapor stream. The establishment of the activated culture resulted in a predominantly black-colored growth on the surface of the wood chips. It is noted that a supply bin containing spare moist wood chips also grew an apparent microbial layer (similar visual appearance) after this bin was used to catch drips from the introduction of the sludge to the eight treatment trays, which suggests that the culture is durable even in nutrient-limited conditions.

Based on a conservative influent concentration of 500 ppmv ethanol this test unit would remove approximately 0.31 pounds of ethanol per hour. This is for a media bed of 7.5 cubic feet, yielding a removal rate of 0.041 pounds/hour/CF of media.

It is expected that when moisture can be maintained at more consistent levels and a greater thickness of biofilm is allowed to accumulate on the media, the treatment system will be able to consume a greater mass loading rate of ethanol. The ductwork and dampers on the treatment unit may be designed such that air can passively flow into the warehouse, but any exiting air must pass through the media trays. Fans may be used to keep air flowing through the media, but since air may be allowed to enter the ducts through one-way valves outside the warehouse, there may be no negative pressure exerted on the warehouse.

For a full scale unit containing 320 CF of media, at removal rates estimated during this test, a removal rate of about 13 pounds of ethanol per hour for each unit may be achieved. A full size unit may thus be capable of handling the angels' share emissions from up to several thousand barrels depending on specific warehouse configuration and air flows.

The removal efficiency generally ranged from 80% to 100% with inlet air concentrations of from 200 to 2,000 ppmv with a media contact time of approximately 5 seconds. Observations indicated that a biofilm was growing on the media, seen as darkened areas in FIG. 10. Since this testing was conducted for a period of less than two full weeks, a more mature system is expected to have a thicker biofilm and will respond much better with higher removal efficiencies and faster response times when subjected to increasing ethanol concentrations.

The removal efficiencies are very high at low concentrations (generally at or near 100% below 500 ppm) and respond well to periods when concentrations are increasing. Removal efficiencies decrease when the media begins to dry, so it is important to keep moisture levels high through frequent spraying of water on the media. It is therefore desirable to monitor moisture levels in an operating system. Although removal efficiencies were near 90% even with inlet concentrations of ethanol up to 2,000 ppmv, removal efficiencies are not high when the system is recovering from very high inlet concentrations (over 1,500 ppmv). A properly cultured and established system that is kept moist in accordance with embodiments of the present invention should consistently remove greater than 90% of the ethanol with influent ethanol concentrations up to 800 ppmv as long as inlet concentrations are not allowed to exceed 1,500 ppmv. Since the present invention utilizes a biological treatment process, the most biologically available form of ethanol that is most likely to cause blackening will be effectively destroyed using the treatment systems of the present invention.

Whereas particular embodiments of this invention have been described above for purposes of illustration, it will be evident to those skilled in the art that numerous variations of the details of the present invention may be made without departing from the invention as defined in the appended claims.

What is claimed is:

1. An ethanol emission treatment system for reducing levels of ethanol generated from a building, the system comprising:
an enclosure comprising at least one inlet opening structured and arranged to provide flow communication with an interior of a building and at least one outlet opening; and
multiple air-permeable microbial support media trays in the enclosure, wherein the multiple support media trays are structured and arranged in the enclosure to hold the microbial support media while allowing airflow through the support media trays from the inlet opening to the outlet opening of the enclosure.

2. The ethanol emission treatment system of claim 1, wherein at least a portion of the support media trays are stacked vertically with respect to each other.

3. The ethanol emission treatment system of claim 2, wherein at least four of the support media trays are stacked vertically with respect to each other.

4. The ethanol emission treatment system of claim 2, comprising at least two sets of the vertically stacked support media trays horizontally offset from each other.

5. The ethanol emission treatment system of claim 2, wherein each of the vertically stacked support media trays are interchangeable in different vertical positions within the vertical stack.

6. The ethanol emission treatment system of claim 1, wherein the support media trays are slidably removable from the enclosure.

7. The ethanol emission treatment system of claim 6, wherein the support media trays are slidably removable in horizontal directions away from the enclosure.

8. The ethanol emission treatment system of claim 1, further comprising microbial support media on the support media trays.

9. The ethanol emission treatment system of claim 8, wherein the microbial support media comprises a cellulosic support material.

10. The ethanol emission treatment system of claim 9, wherein the cellulosic support material comprises wood chips.

11. The ethanol emission treatment system of claim 8, wherein the microbial support media is inoculated with microorganisms comprising bacteria, fungi, algae, protozoa, rotifers and combinations thereof.

12. The ethanol emission treatment system of claim 11, wherein the microorganisms comprise bacteria.

13. The ethanol emission treatment system of claim 11, wherein the microorganisms comprise fungi.

14. The ethanol emission treatment system of claim 1, further comprising an exhaust fan structured and arranged to draw air from the enclosure through the at least one outlet opening.

15. The ethanol emission treatment system of claim 14, wherein the exhaust fan is operable to continuously run.

16. The ethanol emission treatment system of claim 1, further comprising a water delivery system structured and arranged to deliver water into the interior of the enclosure.

17. The ethanol emission treatment system of claim 16, wherein the water delivery system comprises at least one water spray head structured and arranged to spray water onto at least one of the media support trays.

18. A method of reducing ethanol emissions from a building, the method comprising:
drawing ethanol-containing air from a building into a treatment system comprising an enclosure and at least one support media tray containing microbial support media;
passing the ethanol-containing air through the at least one support media tray to contact at least a portion of the ethanol with microorganisms in the microbial support media to thereby allow the microorganisms to oxidize the ethanol; and
exhausting air from the enclosure containing a lower level of ethanol than an ethanol level of the ethanol-containing air drawn into the enclosure.

19. The method of claim 18, wherein the air is exhausted from the enclosure at a rate of from zero to 10,000 cfm.

20. The method of claim 18, wherein the air is exhausted from the enclosure at a rate of from 0.1 to 5,000 cfm.

21. The method of claim 18, wherein the air is exhausted from the enclosure at a rate of from 0.5 to 2,500 cfm.

22. The method of claim 18, further comprising venting ambient air from outside the building into the enclosure.

23. The method of claim 22, wherein the ethanol-containing air and ambient air are introduced into the enclosure together.

24. The method of claim 18, further comprising introducing water into the enclosure to moisten the microbial support media.

25. The method of claim 24, wherein the water is introduced by spraying.

26. The method of claim 18, wherein the microbial support media is inoculated with the microorganisms prior to placement of the microbial support media onto the support media tray.

27. The method of claim 18, further comprising arranging a plurality of the support media trays in a vertical stack in the enclosure.

28. The method of claim 27, further comprising periodically rearranging vertical positions of the support media trays with the vertical stack.

29. The method of claim 18, wherein the exhausted air has an ethanol concentration at least 50 percent less than an ethanol concentration of the ethanol-containing air drawn from the building.

30. The method of claim 18, wherein the exhausted air has an ethanol concentration at least 80 percent less than an ethanol concentration of the ethanol-containing air drawn from the building.

31. The method of claim 18, wherein the exhausted air has an ethanol concentration at least 95 percent less than an ethanol concentration of the ethanol-containing air drawn from the building.

32. The method of claim 18, wherein the exhausted air has an ethanol concentration at least 99 percent less than an ethanol concentration of the ethanol-containing air drawn from the building.

33. Microbial support media inoculated with ethanol-oxidizing microorganisms for use in an ethanol emission treatment system as recited in claim 1.
